(19) United States
(12) Patent Application Publication
(10) Pub. No.: US 2017/0205580 A1
(43) Pub. Date: Jul. 20, 2017

(54) OPTICAL WAVEGUIDE DEVICE USING VERTICALLY STACKED DE-CENTERED BEND STRUCTURES FOR HIGH-TO-LOW INDEX OPTICAL MODE TRANSFORMING

(71) Applicant: LaXense Inc., Walnut, CA (US)

(72) Inventors: Ningning Feng, Arcadia, CA (US); Xiaochen Sun, Walnut, CA (US)

(73) Assignee: LaXense Inc., Walnut, CA (US)

(21) Appl. No.: 14/997,532

(22) Filed: Jan. 17, 2016

(51) Int. Cl. G02B 6/14; G02B 6/125

(52) U.S. Cl. CPC G02B 6/14; G02B 6/125

(57) ABSTRACT

An optical waveguide mode transformer device includes a first optical waveguide bend structure and a second optical waveguide bend structure formed by vertically stacked multiple layers of light transparent media. One of the core layers of the optical waveguide bends has a higher refractive index and the other has a lower refractive index. The waveguide centers of the two optical bend structures are de-centered. The bend structure having higher refractive index core layer terminates at a location of the mode transformer device between its two ends. With proper bend structure design, the optical power can be completely transferred from the high index waveguide to the low index waveguide with the help of such vertical stacked de-centered bend structure.

### BACKGROUND OF THE INVENTION

Field of the Invention

The invention relates to an optical waveguide mode transformer device in vertical integrated multi-layer waveguide optical systems. In particular, the invention relates to an optical waveguide mode transformer using vertically stacked de-centered bend structure for mode transforming from high to low index optical waveguides.

Description of the Related Art

As more bandwidth and longer transmission reach are required by mega datacenters for applications from social networks, cloud service, to big data analysis and high performance computing, optical interconnects are adopted in data communications at unprecedented rate. Unlike optical transceiver modules or subsystems in traditional telecommunication systems, lower cost, more compact and more power efficient optical transceivers or engines are demanded in data communications. Hybrid integration of multiple optical components or chips such as lasers, modulators, photodetectors, switches, attenuators and etc. is one efficient way to reduce assembling cost and footprint.

In such hybrid integrated optical systems, accurately placing and bonding optical chips is a key technology to enable complex optical functionalities. On the one hand, most active optical devices are intended to be fabricated in a high index contrast waveguide systems (or smaller waveguides) to pursue higher operating speed. On the other hand, passive optical devices usually employ low index contract waveguide systems (or larger waveguide) for easier coupling to optical fibers. However, the chip level bonding accuracy highly relies on the placing accuracy of the bonding machine, which is around micrometer level for the state-of-the-art technology. It prevents the direct chip level hybridization of chips with tiny optical waveguides, for example, some high speed active devices, due to the large mismatch loss between optical waveguides. To enlarge the bonding tolerance, the optical devices should have on-chip optical mode transformers that transform the small optical modes (for active devices) into large optical modes (for fibers or passives devices).

Mode transforming from low index to high index waveguides are relatively easy because the light tends to be confined in high index materials. However, the other way round is much harder. Unfortunately, there are lots of application needs to transform modes from high index to low index waveguides, for example in the scenarios of coupling light from lasers/modulators or tiny silicon waveguide to optical fibers.

### SUMMARY OF THE INVENTION

Accordingly, the present invention is directed to an optical waveguide mode transformer device that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides an optical waveguide mode transformer device which includes: a substrate having a lower refractive index; a first optical waveguide bend structure having a core layer with a medium refractive index formed on the substrate; and a second optical waveguide bend structure having a core layer with a higher refractive index formed on top of the first optical bend structure and ending at a location between a first location and a second location along the first optical waveguide bend structure.

In another aspect, the present invention provides an optical waveguide mode transformer device which includes: a substrate having a lower refractive index; a first optical waveguide bend structure having a core layer with a higher refractive index formed on the substrate; and a second optical waveguide bend structure having a core layer with a medium refractive index formed on top of the first optical bend structure, wherein the first optical waveguide bend structure ends at a location between a first location and a second location along the second optical waveguide bend structure.

It is to be understood that both the foregoing general description and the following detailed description are exemplary and explanatory and are intended to provide further explanation of the invention as claimed.

### BRIEF DESCRIPTION OF THE DRAWINGS

FIG. 1 is an illustration of a traditional optical waveguide mode transformer device (prior art).

FIG. 2 is an illustration of an optical waveguide mode transformer device using vertically stacked de-centered bend structure according to an embodiment of the present invention.

FIG. 3 is an illustration of an optical waveguide mode transformer device using vertically stacked de-centered bend structure according to another embodiment of the present invention.

### DETAILED DESCRIPTION OF THE PREFERRED EMBODIMENTS

The invention relates to optical waveguide mode transformer device in vertical integrated multi-layer waveguide optical systems. In particular, the invention relates to an optical waveguide mode transformer using a vertically stacked de-centered bend structure for mode transforming from high to low index optical waveguides. Here, “index” refers to the refractive index. Further, “higher” and “lower” refractive indices should be understood to be relative terms referring to the comparative refractive indices of various components of the optical system.

Optical waveguide mode transformers are very important devices widely used in optical devices. In real applications, optical waveguide mode transformers transform optical modes between waveguides with various dimensions and optical media. The key is to make such transition low loss. Usually, optical mode transforming from waveguides with low refractive index to waveguides with high refractive index is much easier than the opposite way because the light tends to be confined in a medium with higher refractive index. The low-loss mode transformation requires index matching, that is the effective indices of the two waveguides match. To realize it, a common approach is to reduce the effective index of the waveguide with higher refractive index to match the waveguide with lower refractive index.

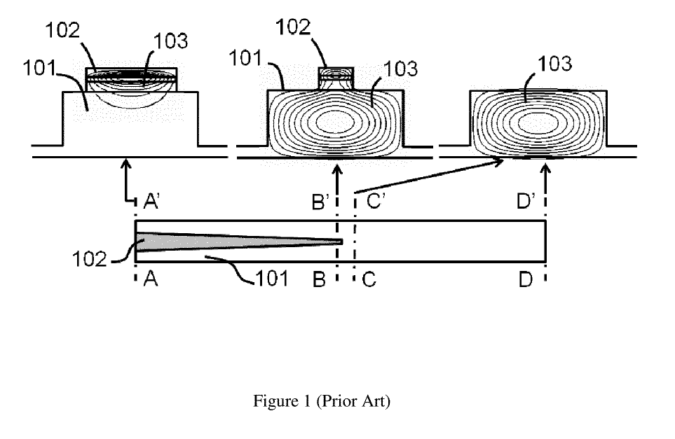

FIG. 1 illustrates a traditional approach to realize an optical waveguide mode transformer in prior art. The optical waveguide cross-sections and optical mode profiles are illustrated in the figure for various locations along the waveguides. The device includes a bottom waveguide 101 with a lower refractive index and a top waveguide 102 with a higher refractive index. The key function of this device is to transform the optical modes 103 confined inside the top waveguide 102 (shown in cross-section A-A′) into the modes confined inside the bottom waveguide (shown in cross-section D-D′).

To match the effective indices of these two waveguides, the top waveguide 102 is tapered down to a narrower tip width so that most of the light (optical mode 103) is squeezed out from the top waveguide 102 into the bottom waveguide 101, therefore reducing the effective index experienced by the mode 103. Due to the index matching, the optical power being squeezed out is gradually coupled into the bottom waveguide 101. At a location of the device between its two ends, the top waveguide 102 is truncated and only the bottom waveguide 101 continues.

However, since the light tends to be confined in waveguide with high index media, the tip width (102 in cross-section B-B′) of such mode transformer needs to be very small so that the light power is completely squeezed out to the bottom waveguide 101. When the index difference between these two waveguides is large, such tiny tip width is extremely challenging to fabricate. With a non-ideal tip width, the optical mode before the truncation point at B-B′ does not match the one after the truncation point at C-C′. Some light is still confined in the top waveguide tip 102 as shown in cross-section B-B′ and will be lost after the tip truncation. It results in a mode truncation loss due to the mode mismatch. In addition, when light propagates through the taper structure 102, there exists mode beating between the modes from the top and bottom waveguides and it causes the undesired wavelength dependence of the mode transforming efficiency.

According to embodiments of the present invention, an optical waveguide mode transformer device includes a first optical waveguide bend structure and a second optical waveguide bend structure formed by vertically stacked multiple layers of light transparent media. One of the core layers of the optical waveguide bends has a higher refractive index and the other has a lower refractive index. The waveguide centers of the two optical bend structures are de-centered. The bend structure having higher refractive index core layer terminates at a location of the mode transformer device between its two ends. With proper bend structure design, the optical power can be completely transferred from the high index waveguide to the low index waveguide with the help of such vertical stacked de-centered bend structure.

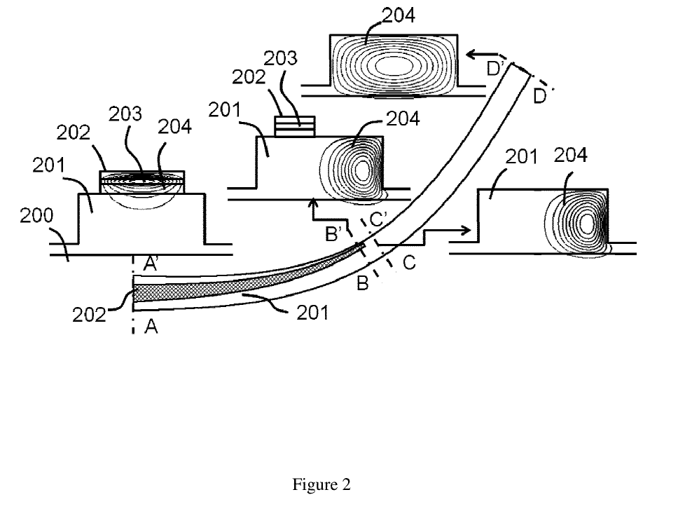

FIG. 2 illustrates an optical waveguide mode transformer device according to an embodiment of the present invention. The cross-sections of the optical waveguides and optical mode profiles at various key locations are illustrated. The device includes a substrate 200 which has a lower refractive index, a bottom optical waveguide bend structure 201 with a medium refractive index above the substrate and a top optical waveguide bend structure 202 with a higher refractive index core 203 above the bottom optical waveguide.

Again, the key function of this device is to transform the optical mode 204 confined inside the top waveguide 202 (shown in cross-section A-A′) into the mode confined inside the bottom waveguide 201 (shown in cross-section D-D′). The main difference between the device shown in FIG. 2 from the traditional approach (FIG. 1) is the use of vertically stacked de-centered bend structures 201/202. Here, de-centered refers to the fact that the center of the top waveguide 202 is de-centered, i.e. shifted, relative to the center of the bottom waveguide 201 in the cross-sectional planes of the waveguides (along at least a part of the waveguides 201 and 202).

It is known that when optical waveguides bend, the light will be thrown out of the waveguide and leaks into the adjacent low index medium. Such phenomenon is wavelength independent and solely determined by the bending radius. With small enough bending radius, the light will be completely thrown out of the waveguide 202 and captured by the bottom waveguide 201 as illustrated in FIG. 2. With proper bend structure design, the optical mode 204 is squeezed to the outside edge of the low index waveguide bend 201 (i.e. the side opposite to the bending direction) such that it has less overlap with the high index waveguide tip 202 at the location of cross-section B-B′ just before the top waveguide is truncated. It therefore leads to almost no transition loss when truncating the high index waveguide tip 202.

To make this device more efficient, two approaches are employed: 1) the top waveguide bend 202 is tapered, i.e., its width decreases gradually along the light propagation direction, the width being defined as the size in a direction parallel to the substrate surface and perpendicular to the light propagation direction; 2) the waveguide centers of the two optical bend structures 201 and 202 are deliberately de-centered so that the top waveguide 202 is shifted away from the bended optical mode 204 (see cross-section B-B′). With such an arrangement, the optical modes before (cross-section B-B′) and after (cross-section C-C′) the truncation point are almost identical even when the width of the top waveguide tip 202 is relatively large at the truncation point. Therefore the truncation of the top waveguide 202 has negligible effect on the optical modes 204 before and after the truncation of the waveguide tip 202. More importantly, such mode transforming approach is solely induced by the waveguide bending and wavelength independent.

It is worth mentioning that the bend structures preferably all have smooth bending radius transitions from infinity (i.e., straight, at location A-A′) to a designated radius (at a location near the truncation point, such as location B-B′) and back to infinity (at location D-D′) at the end of the device to reduce the transition loss induced by the bend to straight waveguide transition.

Preferably, the radius of the bend structure is designed such that at the end of the device (location D-D′), the optical mode 204 substantially returns to the center of the waveguide 202, as illustrated in FIG. 2.

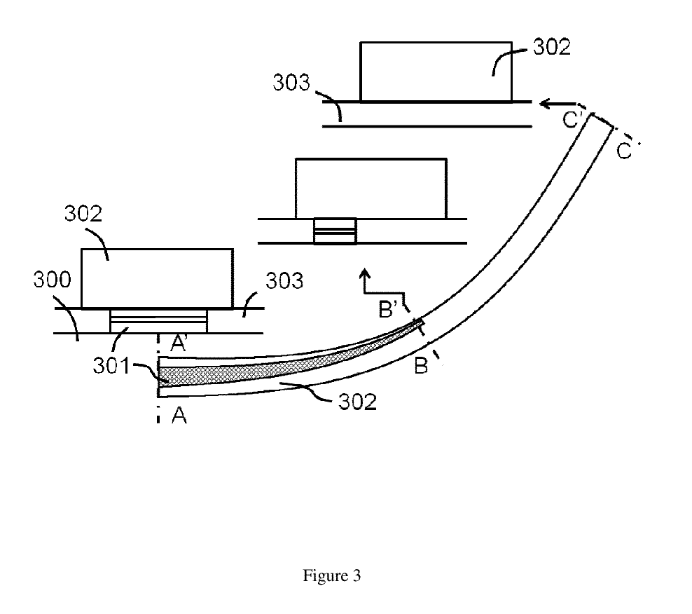

FIG. 3 illustrates an optical waveguide mode transformer device according to another embodiment of the present invention. The device includes a substrate 300 which has a lower refractive index, a bottom optical waveguide bend structure 301 with a higher refractive index buried inside a cladding layer of medium 303 and a top optical waveguide bend structure 302 with a medium refractive index. The bottom optical waveguide bend structure 301 has a tapered shape. The device works on the same principle described above except that the high and low index waveguides' stacking sequence is difference. The refractive indices of the cladding layers 300 and 303 can be the same medium or different depending on the fabrication process.

To summarize, in embodiments of the present invention, the optical mode transformer device employs a vertically stacked de-centered waveguide bend structures. The optical mode confined in a higher index waveguide is thrown out of the high index waveguide and leaks into the low index waveguide bend. With proper bend structure design, the optical mode is squeezed to the outside edge of the low index waveguide bend opposite side to the bending direction such that it has negligible overlap with the high index waveguide tip. It therefore leads to almost no transition loss when truncating the high index waveguide tip.

It is noted that although FIGS. 2 and 3 illustrate simple waveguide structures, in both embodiments, all waveguide structure can be different waveguide types, such as channel or ridge waveguides, with multiple layers.

It will be apparent to those skilled in the art that various modification and variations can be made in the optical system and related fabrication methods of the present invention without departing from the spirit or scope of the invention. Thus, it is intended that the present invention cover modifications and variations that come within the scope of the appended claims and their equivalents.

What is claimed is:

1. An optical waveguide mode transformer device comprising:
a substrate having a lower refractive index;
a first optical waveguide bend structure having a core layer with a medium refractive index formed on the substrate; and
a second optical waveguide bend structure having a core layer with a higher refractive index formed on top of the first optical bend structure and ending at a location between a first location and a second location along the first optical waveguide bend structure.

2. The optical waveguide mode transformer device of claim 1, wherein the first optical bend structure has a gradual bending radius transition from infinity to a designated radius and back to infinity.

3. The optical waveguide mode transformer device of claim 1, wherein the second optical bend structure has a gradual bending radius transition from infinity to a designated radius.

4. The optical waveguide mode transformer device of claim 1, wherein a waveguide center of the second optical bend structure is de-centered from a waveguide center of the first optical bend structure.

5. The optical waveguide mode transformer device of claim 1, wherein the second optical bend structure has a taper width in a direction parallel to a surface of the substrate and perpendicular to a light propagation direction of the second optical bend structure.

6. The optical waveguide mode transformer device of claim 1, wherein the first optical bend structure includes multiple layers with at least one core layer having the medium refractive index.

7. The optical waveguide mode transformer device of claim 1, wherein the second optical bend structure includes multiple layers with at least one core layer having the higher refractive index.

8. An optical waveguide mode transformer device comprising:
a substrate having a lower refractive index;
a first optical waveguide bend structure having a core layer with a higher refractive index formed on the substrate; and
a second optical waveguide bend structure having a core layer with a medium refractive index formed on top of the first optical bend structure, wherein the first optical waveguide bend structure ends at a location between a first location and a second location along the second optical waveguide bend structure.

9. The optical waveguide mode transformer device of claim 8, wherein the second optical bend structure has a gradual bending radius transition from infinity to a designated radius and back to infinity.

10. The optical waveguide mode transformer device of claim 8, wherein the first optical bend structure has a gradual bending radius transition from infinity to a designated radius.

11. The optical waveguide mode transformer device of claim 8, wherein a waveguide center of the first optical bend structure is de-centered from a waveguide center of the second optical bend structure.

12. The optical waveguide mode transformer device of claim 8, wherein the first optical bend structure has a taper width in a direction parallel to a surface of the substrate and perpendicular to a light propagation direction of the first optical bend structure.

13. The optical waveguide mode transformer device of claim 8, wherein the first optical bend structure includes multiple layers with at least one core layer having the higher refractive index.

14. The optical waveguide mode transformer device of claim 8, wherein the second optical bend structure includes multiple layers with at least one core layer having the medium refractive index.
